(19) United States
(12) Patent Application Publication
(10) Pub. No.: US 2026/0054809 A1
(43) Pub. Date: Feb. 26, 2026

(54) PIPE ANCHORING SYSTEM AND DEVICE FOR AUTONOMOUS IN-FLUID ROBOTIC DEVICE

(71) Applicant: Motmot, Inc., Detroit, MI (US)

(72) Inventors: Elliot Smith, Novi, MI (US); Luca Minnich, Greenwich, CT (US); Demetris Coleman, Anapolis Junction, MD (US)

(73) Assignee: Motmot, Inc., Detroit, MI (US)

(21) Appl. No.: 19/378,131

(22) Filed: Nov. 3, 2025

Related U.S. Application Data
(63) Continuation-in-part of application No. 19/015,400, filed on Jan. 9, 2025.
(60) Provisional application No. 63/619,087, filed on Jan. 9, 2024.
(60) Provisional application No. 63/715,021, filed on Nov. 1, 2024.

(51) Int. Cl. B63G 8/00; B25J 11/00; B25J 18/02

(52) U.S. Cl. CPC B63G 8/001; B25J 11/00; B25J 18/025; B63G 2008/004

(57) ABSTRACT

An anchoring system for an autonomous underwater robotic (AUR) vehicle used in fluid pipe inspection is disclosed. The system includes one or more extending or anchoring arms positioned on upper and lower sides of the AUR and a motorized actuator configured to extend and retract the arms under control of an onboard controller. The arms apply a controlled compressive force against an interior pipe wall to secure the AUR while maintaining a non-invasive contact profile that prevents surface damage. Optional features include soft end pads, telescoping or sliding arm structures, compression feedback control, spring-biased retraction, and pressure-resistant housings for submerged use. The controller may automatically synchronize or independently operate the arms to compensate for varying pipe diameters. The anchoring system stabilizes the AUR during inspection, data transfer, or recharging operations within fluid-filled pipelines.

### CROSS-REFERENCE TO RELATED APPLICATIONS

This application claims the benefit of U.S. Provisional Patent Application No. 63/715,021 filed Nov. 1, 2024, titled “PIPE ANCHORING SYSTEM AND DEVICE FOR AUTONOMOUS IN-FLUID ROBOTIC DEVICE”, hereby incorporated by reference in its entirety.

This application is a continuation-in-part of pending application Ser. No. 19/015,400 filed Jan. 9, 2025, which claims priority to provisional patent application 63/619,087 filed Jan. 9, 2024, and titled AUTONOMOUS IN-FLUID ROBOTIC SYSTEM, the subject of which are incorporated by reference in their entirety.

### FIELD

The present disclosure relates robotics and robotics deployment systems, specifically to autonomous robotic units and systems configured for in-fluid operations.

### BACKGROUND

The drinking water infrastructure space, designed predominantly in the mid-20th century, is approaching the end of its functional lifespan. With systems aging, major cities and municipalities are witnessing a significant uptick in system leaks, breaks, and related failures. Most municipalities and water authorities are grappling with a significant lack of visibility into and data in their capital infrastructure assets. The elevating water crises in major cities have further amplified the issue, garnering substantial public awareness about the vital need for water security.

For many infrastructure owners, the cost of assessing the state of their pipeline infrastructure remains prohibitively high causing them to focus solely on the most critical areas. The current state of in-fluid pipeline inspection and maintenance presents challenges in the deployment and retrieval of inspection robots, as well as in the efficient management of the power and data they collect. Accordingly, there remains a need for an improved anchoring system that integrates with existing pipeline infrastructure to enhance the deployment, stabilization, and data-collection capabilities of autonomous robotic units during in-fluid inspection.

### BRIEF SUMMARY

In one aspect, the present disclosure provides an anchoring system for use with an autonomous underwater robotic (AUR) vehicle configured for in-pipe inspection. The system includes at least one extending or anchoring arm positioned on the upper and lower sides of the main body of the AUR, and a motorized actuator that drives extension and retraction of the arms. The upper and lower anchoring arms may be extended simultaneously or individually under the control of an onboard controller to apply a controlled compressive force against the interior wall of a pipe. The arms are designed to maintain a non-invasive contact profile, applying only enough pressure to stabilize the robot without damaging the pipe surface.

In certain embodiments, each anchoring arm includes a soft or resilient end cap or pad that minimizes friction or surface abrasion. The arms may extend from a frame structure mounted to the top and bottom of the AUR and can be configured as sliding or telescoping members that adjust to varying pipe diameters. The motorized actuator may be electric, hydraulic, or pneumatic, and is capable of producing controlled linear motion for precise positioning. A compression control circuit coupled to the controller can monitor the applied force to maintain balanced contact between opposing arms.

In some examples, the anchoring arms may be spring-biased or resiliently loaded, allowing automatic retraction when power is removed. Each arm may be enclosed within a watertight or pressure-resistant housing suitable for extended submerged operation. The controller can further automate deployment and retraction sequences in response to navigation commands or sensor feedback, and may synchronize the extension rate of the upper and lower arms to keep the AUR centered along the longitudinal axis of the pipe.

Additional embodiments include independent control of each arm to compensate for irregular or asymmetric pipe geometries. A sensor interface may detect pipe diameter or wall proximity before anchoring. The anchoring system can also stabilize the AUR during recharging or data-transfer operations using a docking interface or magnetic power transfer module. For safety, a manual override or failsafe release mechanism may be included to retract the arms in the event of power loss or obstruction. The arms may also incorporate articulated or jointed sections to conform to variations in pipe curvature or diameter.

In another aspect, an autonomous underwater robotic system is provided that integrates the anchoring system described herein with an AUR configured to travel within a fluid-filled pipeline. When deployed, the anchoring system enables the AUR to hold position securely during inspection, data acquisition, communication, or recharging cycles.

Other technical features and advantages will become apparent from the following detailed description and the accompanying drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example schematic top view of a quad-thrust robotic unit (AUR) of the present disclosure.

FIG. 2 illustrates a front side view of the quad-thrust AUR of FIG. 1.

FIG. 3 illustrates a side profile view of the quad-thrust AUR of FIG. 1.

FIG. 4 illustrates an example schematic top view of a octo-thrust AUR of the present disclosure.

FIG. 5 illustrates a front view of the octo-thrust AUR of FIG. 4.

FIG. 6 illustrates a side profile view of the octo-thrust AUR of FIG. 4.

FIG. 7 illustrates a schematic flow chart of a control system according to the present disclosure.

FIG. 8 illustrates an example schematic of a quad-thrust AUR with a pipe system at or near a charging station.

FIG. 9 illustrates an example schematic top view of a single rear-thruster AUR of the present disclosure.

FIG. 10 illustrates an example schematic top view of a dual rear-thruster AUR of the present disclosure.

FIG. 11 illustrates a schematic of a manhole access to a pipe system with gate valve and Home Docking Station (HDS) fixed to a water main pipe with communication line to plate at grade.

FIG. 12 illustrates a schematic of a HDS attached to a water main pipe, illustrating attachment, internal piping capture, bleeding, and containment space from a system.

FIG. 13A is a schematic perspective view of an alternative configuration of a quad-thruster AUR designed for efficient movement through a water system.

FIG. 13B illustrates a front view of the quad-thruster AUR of FIG. 13A.

FIG. 14 illustrates a schematic side view of a home docking station (HDS) system of the present disclosure having a chlorination pressure chamber and a secondary chamber.

FIG. 15A illustrates a top side view of the HDS system of FIG. 14 connected to a pipe system.

FIG. 15B illustrates a perspective view of the HDS system of FIG. 14 connected to a pipe system.

FIG. 16 illustrates a schematic view of a pipe anchoring system on an AUR in a closed configuration.

FIG. 17 illustrates a schematic view of the pipe anchoring system of FIG. 16 in an open configuration.

FIG. 18 illustrates a schematic top view of a pipe anchoring system on an AUR in a closed configuration.

FIG. 19 illustrates a schematic side profile view of the pipe anchoring system on an AUR of FIG. 8 in a closed configuration.

FIG. 20 illustrates a schematic side profile view of the pipe anchoring system on an AUR of FIG. 8 in an open configuration.

FIG. 21 illustrates a schematic perspective view of a pipe anchoring system on an AUR using a frame structure and sliding mechanism for extending in a dual arm configuration.

FIG. 22 illustrates a schematic perspective view of an AUR with single extended anchoring arms in an open configuration.

FIG. 23 illustrates a schematic perspective view of a single arm telescoping anchoring system on an AUR.

### DETAILED DESCRIPTION

Commonly owned and related U.S. patent application Ser. No. 19/015,400 discloses an autonomous underwater robotic vehicle (“AUR”) for use in a system and method for inspection of underground and/or underwater assets and infrastructure systems like pipelines and the like. The vehicle and system are configured for drinking water infrastructure assessment; however, it is adaptable to other environments such as oil pipelines and various fluid transport systems.

The present disclosure provides for a Home Docking Station (HDS) that attaches directly to fluid pipelines. This HDS serves as the primary deployment, retrieval, and maintenance hub for one or more AURs. It is designed to interface with the pipeline, deploy AURs into the fluid system, capture them upon completion of their inspection tasks, recharge their batteries, and upload the data gathered to a GIS network. In an example, the capture can be magnetic. The system is also configured to allow single or limited deployment to allow for scheduled evaluation and monitoring or troubleshooting.

The AUR is configured for infrastructure assessment through deployment of the AUR directly into pipelines of a target infrastructure. Some benefits of the present disclosure include, but are not limited to, improvement or elimination of limited visibility and expensive inspection methods, improvement or elimination of traditionally used by pipe infrastructure owners, which often lead to reactive solutions, improvement or elimination of costly emergency recoveries, and reduction or elimination of system interruptions.

Various AUR designs are within the scope of the present disclosure. These various configurations can utilize diverse propulsion systems for varied navigational needs, including the ability to reverse, hover, and bypass obstructions. Its variable sensor suite may include high-resolution cameras, ultrasonic sensors, and probes to detect anomalies and ensure water quality. In an example, these variable sensors may be interchangeable.

In another example, the AUR includes a buoyancy control system with ballast buoyancy control configured to enable positioning. The AUR may further include a power supply and communication system to facilitate extended operations and data relay. The AUR may be configured to integrate with a docking stations configured for data offload and recharging.

The system may be operable for near real-time asset visibility, thus reducing reactive measures and optimizing infrastructure maintenance. The AUR can be tailored for in-fluid pipeline inspections, with an emphasis on aging drinking water infrastructure. This provides a thorough assessment method, alleviating the issues from conventional and limited visibility inspection methods.

Solutions achievable by an AUR of the present disclosure include but are not limited: (i) conducting extended, uninterrupted in-system inspections; (ii) navigating with enhanced mobility, including the ability to reverse and bypass obstructions; and (iii) integrating with proprietary in-system docking stations. An aspect of the present disclosure includes the ability to provide infrastructure owners and communities with cost-effective visibility into their assets and gather near real-time data. This allows for predictive maintenance and diagnostics without costly and challenging exploration.

An AUR of the present disclosure includes a main body, a propulsion system, a controller, a rechargeable power source (i.e., a battery), and one or more sensors. The propulsion system includes one or more thrustors to propel the main body along with the corresponding components in a desired direction. The controller is coupled to the power source and the one or more sensors for collecting data in a data storage module. The AUR is configured to locate within a target asset system, an HDS for both recharging the power source and transferring any collected data. In another example, the AUR can be controlled remotely to obtain data from a target region or area. The AUR main body should be constructed to survive within an underwater or submerged environment.

The AUR vehicles of the present disclosure may be implemented in a variety of propulsion configurations depending on inspection objectives, pipeline geometry, and fluid dynamics. While each AUR shares a common core structure—including a main body, controller, buoyancy control system, power supply, and communication modules—the propulsion arrangement may differ to optimize maneuverability, stability, and energy efficiency in specific operating conditions.

The following examples illustrate representative propulsion system variants that fall within the scope of the present disclosure. The AUR vehicles described herein can employ various propulsion configurations to accommodate different pipeline diameters, flow conditions, and inspection requirements. Each configuration shares the same fundamental architecture—namely, a main body housing a controller, power source, buoyancy system, sensors, and communication components—but differs in the number, orientation, or control of thrusters to achieve desired maneuverability and positional stability within a fluid-filled pipe.

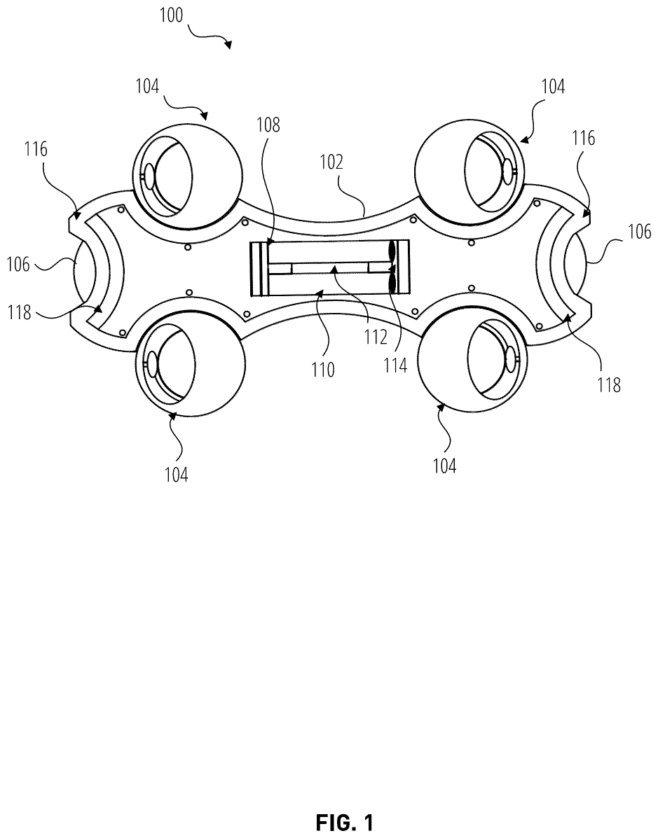

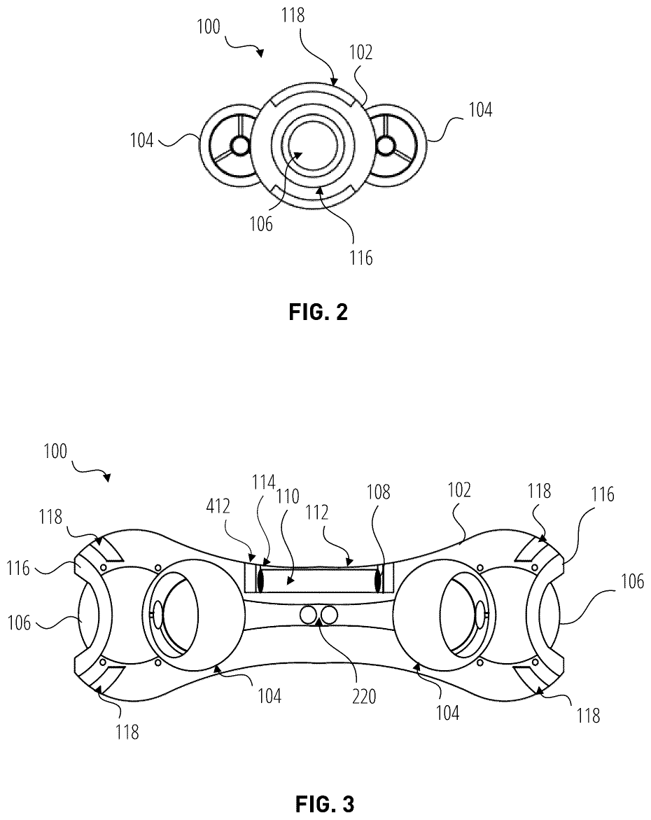

### Quad-Thruster Configuration (FIGS. 1-3, 13A-13B)

In one embodiment, a quad-thruster AUR 100 or 1300 includes four thrusters 104 or 1304 positioned symmetrically around a main body 102 or 1302. The thrusters provide balanced propulsion allowing the AUR to hover, reverse, or maintain position against fluid flow. Optic sensors 106 or 1306 capture image data, while impact bumpers 116 or 1312 protect the main body. A pressure-resistant hull 1314 and internal flexible bladders may be provided for buoyancy adjustment. Lights 118 or 1310 may include red, green, and blue (“RGB”) structured illumination sensors for visual inspection.

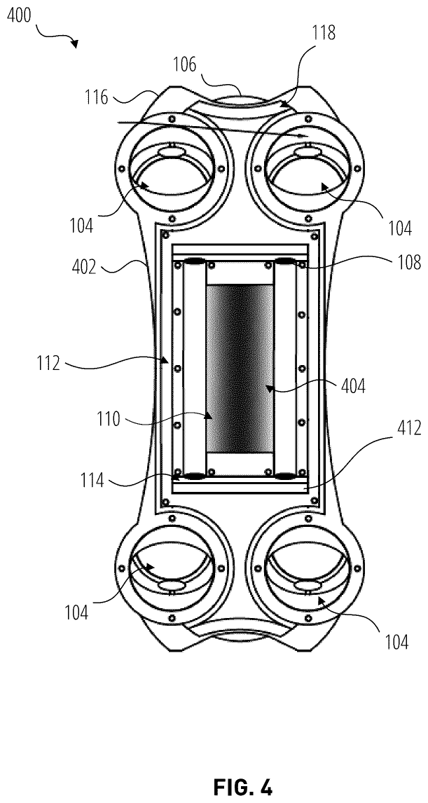

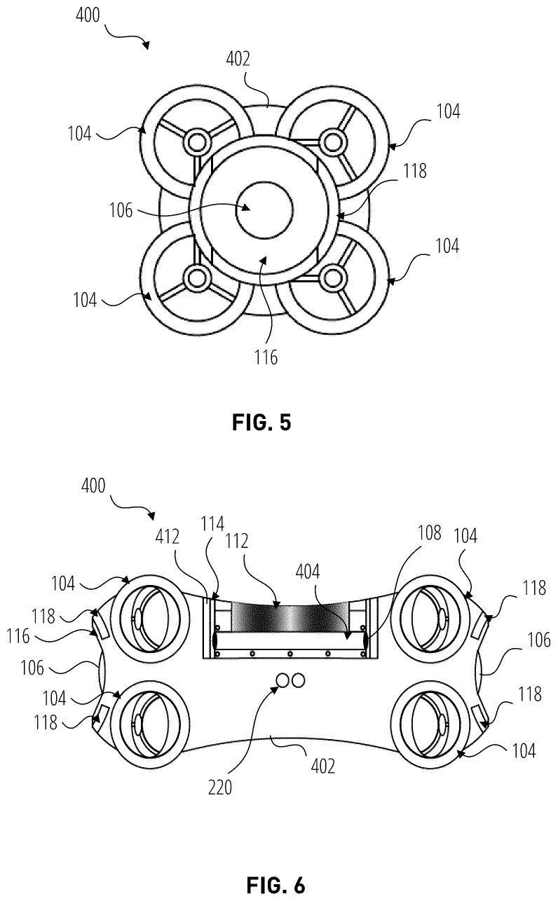

### Octo-Thruster Configuration (FIGS. 4-6)

In another embodiment, an octo-thruster AUR 400 includes eight thrusters 104 arranged around an octo-thrust main body 402. This configuration enhances multi-axis maneuverability and provides fine control in turbulent or large-diameter pipe environments. The AUR may include high-resolution cameras 106, impact bumpers 116, and a hull gap 114 for buoyancy control and sensor placement. A sonar sensor 220 positioned on each lateral side facilitates distance measurement and wall mapping.

### Vectored-Thrust and Hybrid Configurations

A vectored-thrust variant includes pivoting thrusters 104 that change angle relative to the AUR body to enable sharp turns and rapid altitude adjustments. A hybrid propulsion variant may combine rear thrusters, supplemental vectored thrusters, and vertical control units, balancing speed, maneuverability, and energy efficiency.

### Vertical-Thruster Configuration

In another embodiment, an integrated vertical-thruster variant includes upward- and downward-facing thrusters to navigate vertical or inclined pipeline segments. This arrangement allows the AUR to perform detailed vertical scans or hover precisely in riser sections.

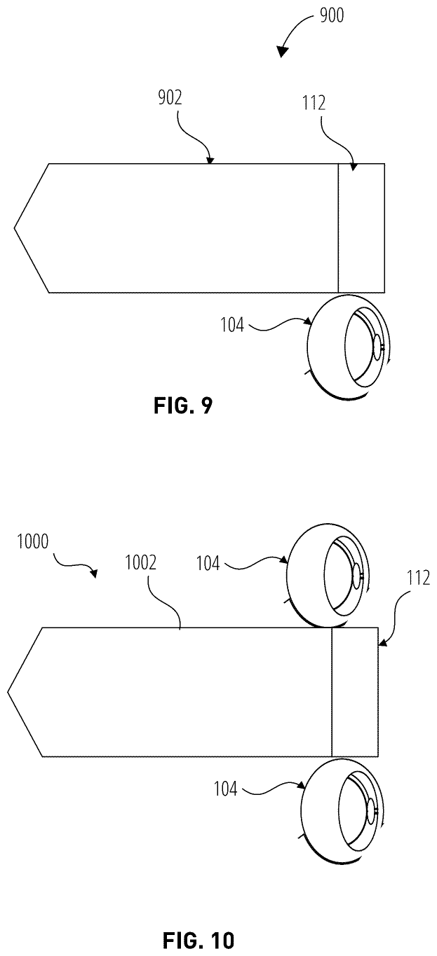

### Single and Dual Rear-Thruster Configurations (FIGS. 9-10)

Simplified propulsion arrangements are also contemplated. A single rear-thruster AUR 900 employs one propulsion unit 104 for streamlined, linear movement suitable for straight pipe segments. A dual-thruster AUR 1000 includes twin rear thrusters 104 on a dual-thrust main body 1002, providing higher speed and stability in faster fluid flows or wider pipelines.

Referring to FIGS. 1-3, a quad-thruster AUR 100 is provided. In this example, four thrusters 104 are positioned symmetrically around quad-thruster main body 102. The thrusters 104 are configured for maneuverability and to hover or remain stationary against fluid flow. In this example, the quad-thruster AUR 100 includes one or more optic sensors 106. Optic sensor 106 may include a high-resolution camera for capturing image information. Impact bumpers 116 are positioned around quad-thruster main body 102. The impact bumpers 116 are provided to protect quad-thruster AUR 100's physical integrity and internal components. A pressure-resistant hull can be included and crafted from lightweight, yet durable materials, ensuring structural integrity under potential high pressures. The quad-thruster main body 102 may further include internal flexible bladders that can be filled or emptied to tune buoyancy, ensuring positive positioning during inspections.

The quad-thruster main body 102 includes a body core 112 for housing the power source, navigation, and communication control through a controller. The body core 112 may include a ballast system 108 for buoyancy control actuation, power transfer magnet capture 110 for power transfer when recharging. In this example, a hull gap 114 is provided for additional buoyancy control, and positioning of a pressure sensor, a temperature sensor, and/or a conductivity probe. Positioned next to the optic sensor 106 and impact bumper 116 is a light 118 which may include red, green, blue (“RGB”) light structured sensors. In this example, a data transfer capture 412 is included in the body core 112. In an example, the data transfer capture 412 is magnetic data transfer. The quad-thruster AUR 100 may also include a sonar sensor 220 shown as a pair of sensors for transmitting and receiving.

In another embodiment, a vectored thrust variant is provided. In this example, the AUR is equipped with pivoting thrusters 104 that can change angles relative to the quad-thruster main body 102. This design variant offers additional precision and directional control and the ability to make sharp turns or rapid altitude adjustments.

Referring to FIGS. 4-7, an octo-thrust AUR 400 is shown having an octo-thrust main body 402. In this example, eight thrusters 104 are positioned around octo-thrust main body 402. These thrusters 104 are configured for maneuverability and to hover or remain stationary against fluid flow. In this example, the octo-thrust main body 402 includes one or more optic sensors 106 that may include a high-resolution camera for capturing image information within a target asset system. The octo-thrust main body 402 further includes impact bumpers 116 to help protect the physical integrity of the octo-thrust AUR 400 and any internal components.

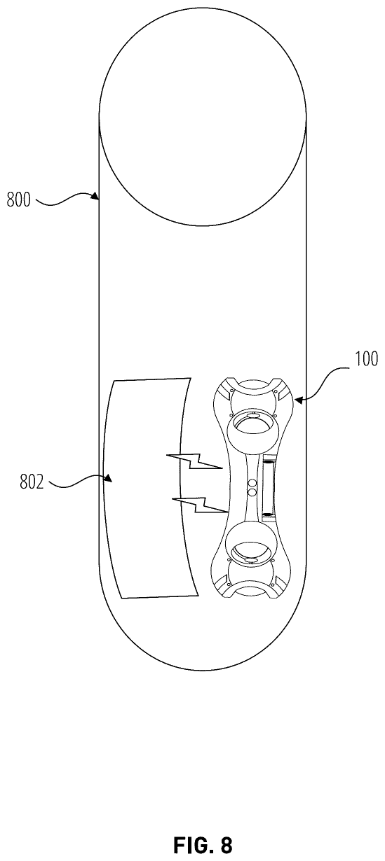

In this example, octo-thrust AUR 400 includes a body core 112 provided for housing the power source, navigation, and communication control through a controller. The body core 112 may include a ballast system 108 for buoyancy control actuation, power transfer magnet capture 110 for power transfer when recharging at an HDS (i.e., HDS 802 of FIG. 8). A hull gap 114 is provided for additional buoyancy control. The hull gap 114 may also allow for positioning of a plurality of sensors including, but not limited to a pressure sensor, a temperature sensor, and/or a conductivity probe.

Positioned next to the optic sensor 106 and impact bumper 116 is a light 118. Light 118 may include RGB light structured sensors. A data transfer capture 412 is provided in the body core 112. The octo-thrust AUR 400 may also include a sonar sensor 220 shown as a pair of sensors for transmitting and receiving. The sonar sensor 220 is positioned on both lateral sides of the octo-thrust AUR 400.

In a further example, an integrated vertical thruster variant includes vertical movement with specialized upward and downward facing thrusters. This variant is suitable for pipes with significant vertical segments or when inspections require meticulous vertical scans. The octo-thrust AUR 400 of FIGS. 4-6 may be a suitable solution for this type of system.

In yet another example, a hybrid propulsion variant is provided. This variant includes a robotic unit with primary rear thrusters 104, supplemental vectored thrusters, and vertical control units. This example may be suitable for balance of speed, maneuverability, and vertical movement capabilities.

The present disclosure relates to a system for comprehensive and efficient inspection of in-fluid pipelines. This includes inspection and assessment of drinking water infrastructure. The AUR, based on its specific variant, can be deployed into a pipeline system via an access point or manhole. Its size and shape should be configured to accommodate for minimal disruption during entry.

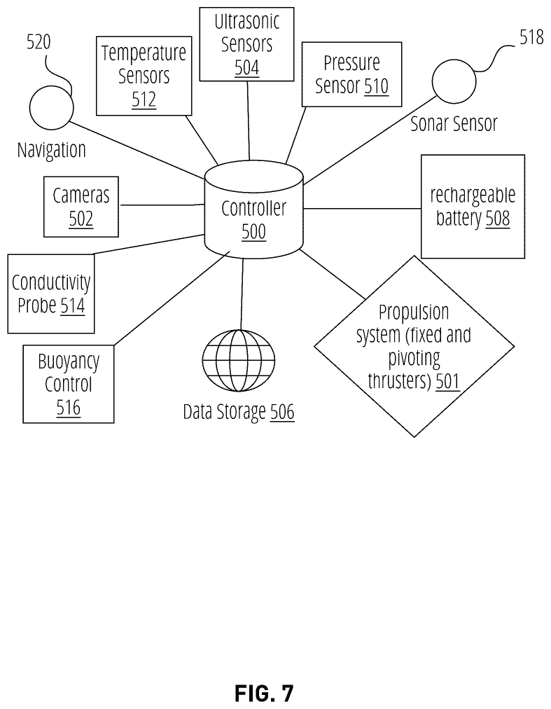

Referring to FIG. 7, a schematic configuration map is provided to illustrate the various options available for an AUR system of the present disclosure. In this example, a central controller 500 is provided. The controller is coupled to the propulsion system 501 for actuating and maneuvering of any thrusters 104. Propulsion system 501 may include fixed and pivoting thrusters, with varying degrees of freedom and symmetry allow for unit control to enable velocity and stability.

Controller 500 is coupled to one or more sensors or data gathering instruments. These may include, but are not limited to one or more cameras 502, like a high-resolution camera. The cameras 502 can be positioned at strategic locations on an AUR body. The cameras 502 can be configured to provide live visual data of a pipeline's interior. Ultrasonic sensors 504 may also be included and used to detect wall thickness, anomalies, and potential breaches in the pipeline. A pressure sensor 510 can be coupled to the controller for measuring internal fluid pressure and identifying any abnormal spikes or drops which could signify an issue. Temperature sensors 512 are configured to detect unusual temperature changes which could affect the quality and safety of the water. A conductivity probe 514 can be provided to monitor fluid system purity and signal if any foreign contaminants are present.

Controller 500 is coupled to a buoyancy control system 516 that includes a ballast tank to allow the AUR to adjust real time buoyancy, aiding in navigation, especially in variable oriented pipeline segments. A power supply (e.g., rechargeable battery 508) may include a battery pack of high-capacity, rechargeable battery units (i.e., lithium powered, or other) that provide extended operational time. In this example, charging is achieved through power transfer magnet capture 110. The AURs of the present disclosure may further include a wireless communication module that enables docking data transmission and allows HDS 802 to remotely control, when the AUR is in vicinity, when necessary. The controller 500 should include data storage 506 which can be a high-capacity data storage with backup redundancy measures. Navigation 520 can be configured to direct an advanced propulsion system 501 and incorporate machine learning as the AUR navigates through the pipeline.

FIG. 8 illustrates a schematic of a target pipe asset pipe system 800 with a quad-thruster AUR 100 provided therein. When ready, quad-thruster AUR 100 is configured to find the docketing HDS 802 for recharging the rechargeable battery 508 and offloading or communicating any data obtained by the sensors.

Referring to FIG. 9, in one embodiment, a single rear-thrust AUR 900 includes a single-thrust AUR 902, a body core 112, and a single rear propulsion thruster 104. This configuration can be suitable for straight-line inspections and simple navigational tasks.

Referring to FIG. 10, in another example, the present disclosure provides for a dual-thruster AUR 1000. The dual-thrustor AUR 1000 includes a dual-thrust main body 1002, a body core 112, and twin rear propulsion thrusters 104 for increased speed and stability, especially beneficial in larger diameter pipes or faster flowing fluid conditions.

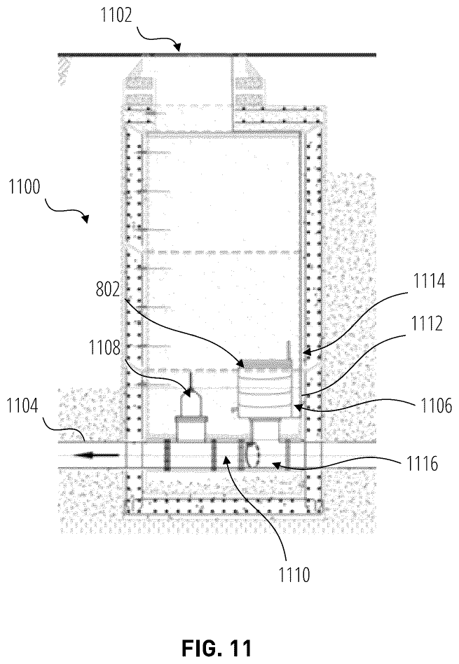

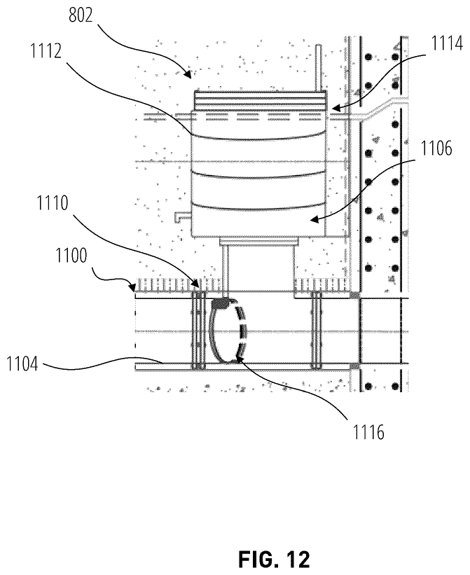

Referring to FIG. 11 and FIG. 12, an example HDS 802 is shown schematically within a fluid pipe system 1100. The HDS is configured to facilitate deployment, retrieval, recharging, and data management of AURs within fluid pipe system 1100. The HDS 802 is characterized by its multi-functional design that provides an effective interface between the AURs and the fluid pipe systems 1100 for which they are intended.

HDS 802 includes a secure entry point 1110 into the fluid pipe system 1100, which is equipped with a mechanical sealing mechanism. This seal ensures that there is no leakage of fluid when AURs are deployed or retrieved, maintaining the integrity of the fluid pipe system 1100. An exterior housing 1112 of the HDS 802 can box-shaped and should be robust and designed to withstand environmental factors. It includes a reservoir 1106 for draining fluid, which can be utilized during maintenance of the HDS 802 or in the event of an overflow, to maintain water quality and manage excess fluid effectively.

The HDS 802 is equipped with a communication and sensory array 1114 having a plurality of sensors for detecting the proximity of an AUR. These sensors enable the HDS 802 to prepare for the docking process as an AUR approaches. The HDS 802 includes a communication module that allows operators to remotely instruct the HDS 802 to deploy AURs into the system, including any secondary AURs if required.

Internally, the HDS 802 features a magnetic capture mechanism that aligns and secures the AUR upon re-entry onto the HDS-pipe junction. This magnetic capture system also functions as an inductive charging platform, providing the power required to recharge the power source of the AUR, such as rechargeable batteries 508. The HDS 802 also includes a data transfer interface. The magnetic capture mechanism is equipped with data transfer capabilities. Upon docking, the AUR engages in a data upload with the HDS 802, transferring gathered inspection data for processing and subsequent relay to a GIS and/or cloud network.

The HDS 802 can be designed to be installed within existing access points in the fluid pipe system 1100, such as gate valves 1108 or manholes 1102. This allows for easy access by maintenance personnel and integration into the pipeline infrastructure. Water quality management can be integral to the design focused on maintaining the water quality within the fluid pipe system 1100. The reservoir 1106 and associated mechanisms ensure that the introduction and operation of the HDS 802 does not compromise the quality of the fluid within the fluid pipe system 1100.

The present disclosure provides for secondary deployment capabilities. In the case of extensive pipeline systems or specific inspection requirements, the HDS 802 can communicate the need for additional AUR deployment, ensuring comprehensive coverage and inspection continuity. Regarding operational protocol, the HDS 802 operates under a set of protocols that govern the deployment frequency, retrieval operations, charging cycles, and data management processes. These protocols ensure the efficient and reliable functioning of the AURs and the overall inspection system.

The present disclosure relates to support systems for in-pipe robotic operations, particularly to a docking station designed for in-system servicing of AURs without deployment or retrieval capabilities. The maintenance and inspection of fluid pipe systems are enhanced using AURs. However, the complexity and cost of a dedicated HDS that deploy and retrieve AURs can be challenging for some to adopt. In an example, a solution is provided that includes in-system support to AURs, extending their operational range and effectiveness without an HDS. The present disclosure provides for an Auxiliary In-System Docking Station (AISDS) that provides in-system recharging and data upload capabilities for AURs. The AISDS is designed to be installed within fluid pipe systems more frequently and at a lower cost, addressing the need for regular maintenance without the mechanical complexities of deployment and retrieval.

In an example, the present disclosure provides for an AISDS including:
(i) a magnetic capture system to secure AURs as they navigate close to the station. This allows for alignment and coupling between the AUR and the AISDS, ensuring a reliable connection for power transfer and data exchange;
(ii) a recharging system for delivering a rapid and efficient transfer of energy to recharge the batteries of the AUR, once docked, and can be configured for reduction or minimal downtime and extended operational periods for the AUR within the pipeline system;
(iii) a data transfer interface including a high-speed data transfer interface that facilitates the upload of gathered inspection data from the AUR to a centralized GIS and/or cloud network, wherein this interface can be designed to handle robust data packages and ensure integrity during transfer;
(iv) a communication module configured for managing data upload processes and receiving operational commands from external operators, wherein the module can signal the need to deploy secondary AURs from an HDS or adjust inspection protocols based on real-time analytics;
(v) an energy storage unit that maintains a continuous power supply, ensuring that AURs can be recharged as needed, even in the event of interruptions to the primary power source; and
(vi) construction materials chosen for durability and compatibility with the internal environment of fluid pipelines including materials resistance to corrosion, fluid pressures, and varying temperatures.

Some design considerations for the AISDS features can include ensuring it does not impede the flow of fluid within the pipeline. Its profile can be configured such that it can be installed without significant modifications to the pipeline structure, maintaining the integrity and throughput of the system. The AISDS can further include self-diagnostic capabilities such as performing self-diagnostic checks to monitor its functional status. Should any component fall below optimal performance levels, the station can autonomously notify operators for maintenance or intervention. The AISDS can further be designed with modularity in mind, allowing for the easy replacement of its components.

The AISDS can further include a collapsible structure for ease of installation in older or irregularly shaped pipeline systems. The recharging system can be configured to include an energy harvesting mechanism that utilizes fluid flow within the pipeline to generate power for its operations. In another example, an integrated fluid sampling mechanism is provided for collecting and analyzing fluid quality within the pipeline. A self-diagnostic system can be provided that is configured to automatically notify operators of required maintenance or repairs through a secure communication network. In an example, a multi-AUR management module is provided that is configured to simultaneously recharge and communicate with multiple AURs.

The present disclosure further provides for in-pipe AUR locator rings 1116 installed within a fluid pipe system 1100 for detecting and tracking in-pipe AUR operations. In the field of pipeline inspection and maintenance, the ability to track the location of AURs can be valuable for efficient operation and management. Many systems lack a dedicated mechanism for precise, real-time tracking of AURs within pipeline systems, which can lead to difficulties in managing inspection routines and rescuing AURs that may become incapacitated or lost. Using locator rings 1116 that are affixed to the interior of pipes 1104 at intermittent distances can alleviate these issues. The locator rings 1116 can be equipped with sensors capable of detecting the passage of AURs, facilitating live tracking, and communication between the AURs, docking stations, and home base. In the event of an AUR failure, these locator rings 1116 serve a role in pinpointing the location of the AUR, enabling swift diagnostic and retrieval actions.

In an example, a locator ring 1116 includes:
(i) a series of sensors that detect the presence and movement of AURs within the fluid pipe system 1100; and these sensors can be configured to identify specific AURs based on their unique signatures;
(ii) a communication system configured to send real-time data regarding the position of the AUR relative to the docking stations and home base, and the system can be configured to use encrypted signals to maintain security and integrity of data;
(iii) navigation assistance to the AURs by providing them with positional feedback, allowing for adjustments in their inspection routes as necessary;
(iv) diagnostic functionality in the event of an AUR becoming stationary due to a malfunction or obstruction, wherein the locator rings 1116 can perform diagnostics to assess the situation and help determine the exact location of the AUR for retrieval purposes;
(v) construction materials chosen for durability and compatibility with the internal pipeline environment, ensuring and/or assisting with long-term functionality without degradation;
(vi) an optional energy harvesting mechanism that leverages kinetic energy of fluid flow to power their operations; and
(vii) optional modularity to allow for easy installation at various points along the pipeline without the need for extensive modifications, suitable for a range of pipe diameters and profiles.

Installation and access can be achieved by selecting a locator ring design to be installed within existing access points in the fluid pipeline system, such as gate valves or manholes. This allows for easy access by maintenance personnel and integration into the pipeline infrastructure.

The locator ring configuration can further include a mechanism to identify specific AURs by unique electronic signatures and relay this data to a centralized management system. An energy harvesting system is configured to convert kinetic energy from fluid flow into electrical power for extended operations. A modular attachment system can be provided that allows for rapid deployment and removal without disrupting pipeline operations. A communication module is configured to transmit encrypted real-time data regarding AUR positions and diagnostics to both docking stations and remote operators. A navigation assistance system can further be included to provide directional guidance and real-time positional feedback to AURs within the communication tributary of the pipeline.

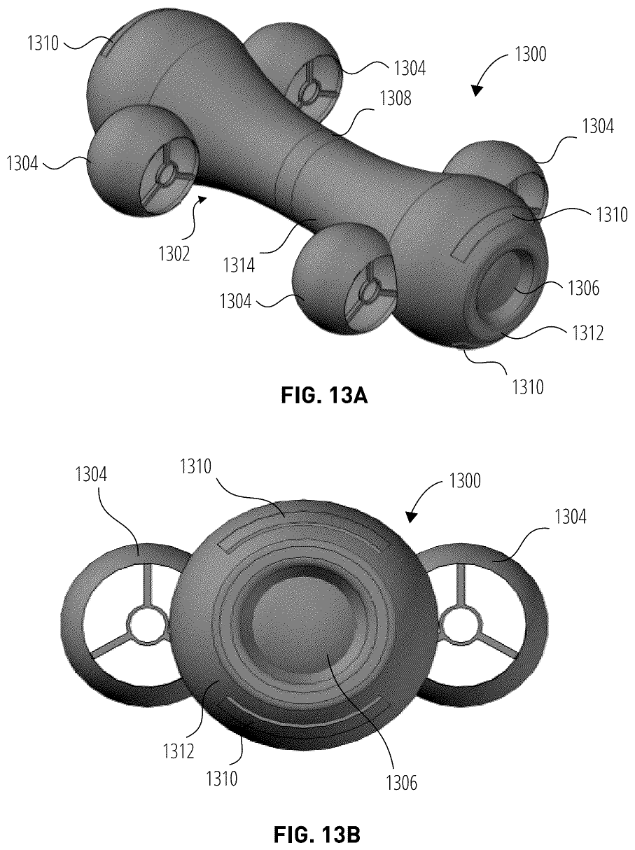

Referring to FIG. 13A and FIG. 13B, a quad-thruster AUR 1300 is provided. In this example, four thrusters 1304 are positioned symmetrically around quad-thrust quad-thruster main body 1302. The thrusters 1304 are configured for maneuverability and to hover or remain stationary against fluid flow. In this example, the quad-thruster AUR 1300 includes an optic sensor 1306. Optic sensor 1306 may include a high-resolution camera for capturing image information. The optic sensor 1306 is positioned on a front side of the quad-thruster AUR 1300 and slightly inset of the quad-thruster main body 1302. This provides damage protection during use when contacting unintentional objects. In this example, the optic sensor 1306 is circular and may include a protective door that opens and closes to further protect the optic features. Impact bumpers 1312 are positioned around optic sensor 1306 and integrated with quad-thruster main body 1302. The impact bumpers 1312 are also provided to protect quad-thruster AUR 1300's physical integrity and internal components. A pressure-resistant hull 1314 is provided and crafted from lightweight, yet durable materials, ensuring structural integrity under potential high pressures. The quad-thruster main body 1302 may further include internal flexible bladders that can be filled or emptied to tune buoyancy, ensuring positive positioning during inspections.

The quad-thruster main body 1302 includes a body core 1308 for housing the power source, navigation, and communication control through a controller. Similar to the quad-thruster AUR 100, the body core 1308 may include a ballast system 108 for buoyancy control actuation, power transfer magnet capture 110 for power transfer when recharging. In this example, two oppositely positioned lights 1310 are positioned next to the optic sensor 1306 and impact bumpers 1312, which may include red, green, blue (“RGB”) light structured sensors. Thrusters 1304 are generally linear thrusters, however, they can be modified to tilt to facilitate additional maneuverability.

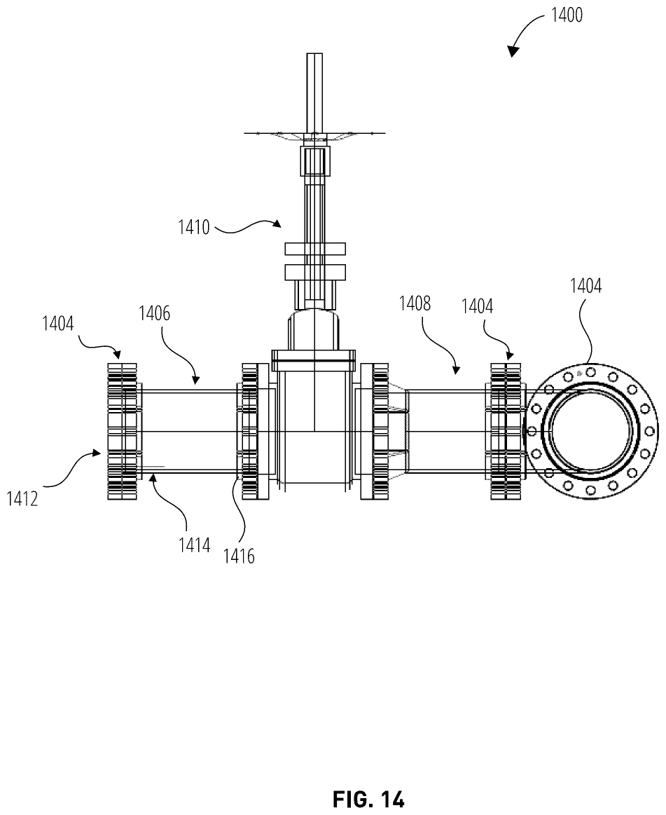

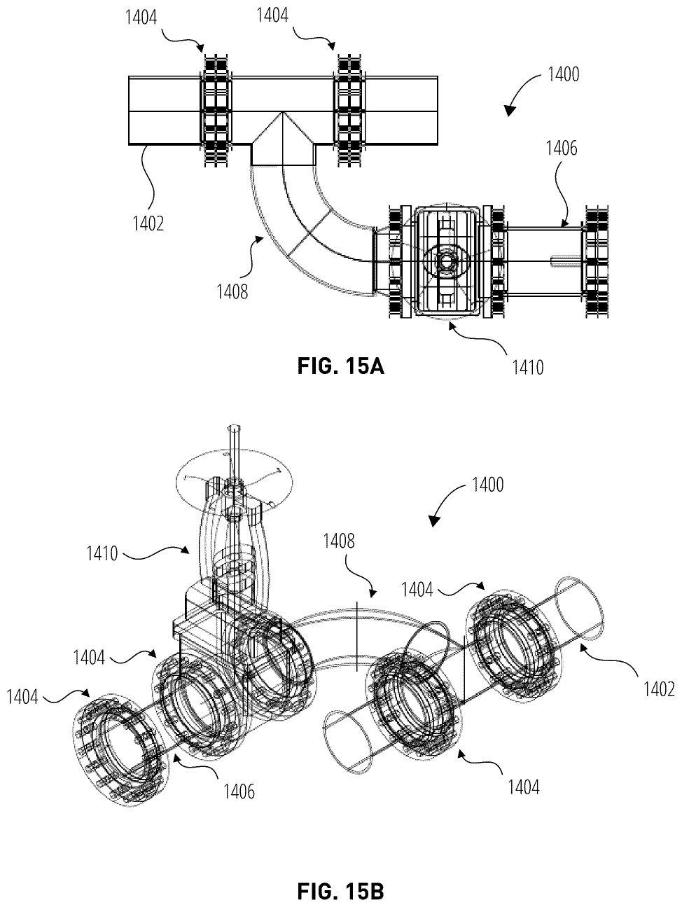

Referring to FIG. 14, FIG. 15A and FIG. 15B, the present disclosure provides for an alternative HDS system referred to as a pressure chamber HDS system 1400 shown schematically within a pipe system 1402. Pressure chamber HDS system 1400 is configured to facilitate deployment, retrieval, recharging, and data management of AURs within pipe system 1402 and includes a communication module. It is characterized by its multi-functional design that provides an effective interface between the AUR and the pipe system 1402 for which they are intended. In this example, the pressure chamber HDS system 1400 can be introduced into a pipe system 1402 and allow for the AUR to be removed as needed for access, maintenance, etc. After data is collected. In another example, pressure chamber HDS system 1400 includes a chlorination pressure chamber 1406 that is removable and accessible without interruption of an existing pipe system 1402.

Pressure chamber HDS system 1400 includes a chlorination pressure chamber 1406 having a stop or opening/exit door 1412. Opening/exit door 1412 allows for access to 1406 to retrieve or access the AUR. The system can further include an emergency pressure release mechanism in the chlorination pressure chamber 1406 to safeguard against unexpected pressure surges or system malfunctions.

In this example, the pressure chamber HDS system 1400 is connected to pipe system 1402 and includes a secondary chamber 1408 for initial entry of the AUR for data transmission, power charging, and/or holding until the system is ready to move the AUR into 1406. The pressure chamber HDS system 1400 can further be equipped with a fluid sampling and treatment module for testing and managing water quality before reintroducing fluid into the main pipeline. Chlorination pressure chamber 1406 can even further include an integrated flushing mechanism to ensure any residual contaminants are removed prior to AUR re-entry into the pipeline. The chlorination module can be coupled with an automated fluid balancing system that ensures the reintroduction of water from the pressure chamber to the pipeline meets regulatory standards for chemical composition and flow rate.

Several pipe connections 1404 are shown for connecting to 1402. In an example, pipe connection 1404 can be a flanged connection including a saddle joint and/or a tapping sleeve or other feasible appurtenance connections. chlorination pressure chamber 1406 includes a Light Fidelity (Li-Fi) Sensor 1414 to facilitate cross communication with the AUR to communicate location information and identity. A bleed valve 1416 is also provided that is configured to adjust the pressure within the chlorination pressure chamber 1406. The Li-Fi sensor 1414 is configured to transmit high-speed data between the pressure chamber HDS system 1400 and the AUR and optionally supports alternative communication methods such as acoustic signals or radio-frequency transmissions to adapt to pipeline conditions. In another example, the system further includes a multi-channel communication module that simultaneously supports Li-Fi, sound-based signals, and radio-frequency transmission for redundant and reliable data exchange between the HDS and the AUR. The system can include adaptive functionality to switch between Li-Fi and sound-based signals based on environmental conditions such as turbidity or obstructions in the fluid pipeline. The communication module can be equipped with high-speed Li-Fi transmitters embedded within the 1406 to facilitate uninterrupted communication with the AUR during operations.

Pressure chamber HDS system 1400 further includes a gate valve 1410 that allows the AUR to advance from the secondary chamber 1408 to the chlorination pressure chamber 1406. Secondary chamber 1408 can include magnetic inductance for energy and data transfer. Gate valve 1410 can be an automatic or a manual gate valve. An automated control system is configured to regulate the opening and closing of the gate valve in synchronization with the chlorination pressure chamber 1406 operations to maintain system integrity during AUR deployment and retrieval. In this example, a gate valve 1410 is provided, however, it is within the scope of the present disclosure that other suitable valves or valve constructions can be used such as, for example, butterfly valves, ball valve, etc. Gate valve 1410 is configured to isolate the pressure chamber during maintenance or AUR deployment to ensure minimal disruption to the pipeline. The gate valve 1410 can include a mechanism configured to be remotely operable via the HDS communication module to allow for precise, on-demand control during AUR deployment and retrieval.

Pressure chamber HDS system 1400 features a magnetic capture mechanism that aligns and secures the AUR upon re-entry into an HDS-pipe junction. This magnetic capture system also functions as an inductive charging platform, providing the power required to recharge the power source of the AUR. Pressure chamber HDS system 1400 may also include a data transfer interface. The magnetic capture mechanism is equipped with data transfer capabilities. Upon entry, the AUR engages in a data upload transferring gathered inspection data for processing and subsequent relay to a GIS and/or cloud network. A real-time diagnostics module can be provided for monitoring pressure levels, fluid composition, and system integrity within the chlorination pressure chamber 1406 and a corresponding pipeline connection.

Pressure chamber HDS system 1400 can be designed to be installed within existing access points in the pipe system 1402, such as gate valves 1410. This allows for easy access by maintenance personnel and integration into the pipeline infrastructure. Water quality management can be integral to the design focused on maintaining the water quality within the pipe system 1402.

Pressure chamber HDS system 1400 can be provided as a modular system that allows for rapid adaptation to different pipeline diameters and profiles without significant structural modification. In an example, the docking station can include an integrated cleaning system configured to remove debris and contaminants from the AUR surface upon docking.

In another example, the docking station can further include a predictive analytics system configured to determine optimal deployment schedules for the AUR based on historical pipeline inspection data and real-time conditions. The communication and sensory array can include an encryption module to secure data transmitted between the docking station and external systems.

The HDS of the present disclosure can include an automated firmware update mechanism to enhance the functionality of docked AURs. Pressure chamber HDS system 1400 provides for a pressure chamber configured to facilitate safe entry and retrieval of the AUR into and from the connected fluid pipeline system. The pressure chamber is configured to maintain environmental equilibrium to prevent pressure surges or leaks in the pipeline.

The chlorination pressure chamber 1406 can further include a chlorination module to neutralize contaminants from the water before interacting with the AUR, ensuring safe operational conditions for AUR equipment.

Chlorination pressure chamber 1406 can be configured to automatically monitor and adjust the chemical composition of the water within the pressure chamber to maintain compatibility with AUR materials and sensors. It can also include a safety interlock system that prevents the gate valve 1410 from opening unless it is confirmed that a balanced pressure state with the connected pipeline system.

Pressure chamber HDS system 1400 should be constructed of materials resistant to chemical corrosion, ensuring long-term operational integrity in treated water environments. It may also include an environmental monitoring system integrated with the chlorination pressure chamber 1406 to detect and log conditions such as temperature, pH levels, and chemical concentrations during AUR deployment.

The present disclosure provides for failover protocols to ensure continued operation of the system in the event of partial component failure. The system can be configured to coordinate simultaneous deployments of multiple AURs to inspect separate pipeline segments concurrently. In an example, the system integrates augmented reality technology to allow operators to visualize pipeline inspection data in near real-time. In yet another example, a centralized data management system is deployed that uses synthetic datasets to train machine learning algorithms for enhanced inspection and predictive maintenance. In yet an even further example, all components, including AURs, docking stations, AISDS, and locator rings, are designed to be interoperable with third-party infrastructure management systems.

The present disclosure provides for a method of using the system or systems as described above that includes the steps of deploying a plurality of AURs from a single docking station to perform synchronized inspections of multiple pipeline systems. The method can further include analyzing inspection data in real-time using AI-driven analytics to generate predictive maintenance schedules for pipeline infrastructure. The docking station can be configured to dynamically adjust AUR deployment based on real-time pipeline pressure, flow rates, and detected anomalies. The method can further utilize locator rings to pinpoint the exact location of pipeline breaches or AUR malfunctions during disaster recovery operations. Energy harvested from pipeline fluid flow can power some or all system components, ensuring sustainability during extended operations.

The present disclosure also provides a variety of anchoring system configurations designed to stabilize an autonomous underwater robotic (AUR) vehicle within a fluid pipe during inspection, recharging, or data-transfer operations. Each configuration shares the same functional purpose—temporarily securing the AUR in a fixed position without damaging the pipe interior—but may differ in the number, arrangement, and actuation mechanism of the extending arms. The following examples illustrate representative anchoring system variants that fall within the scope of the present disclosure.

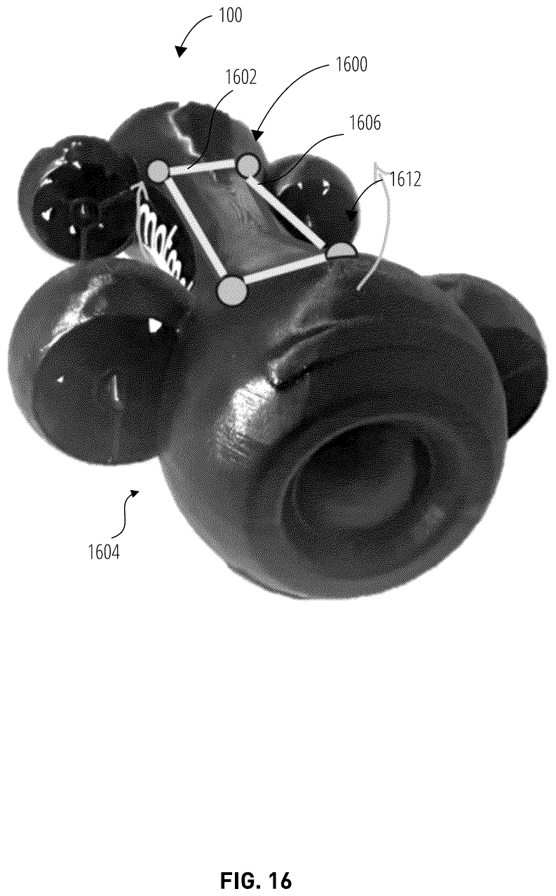

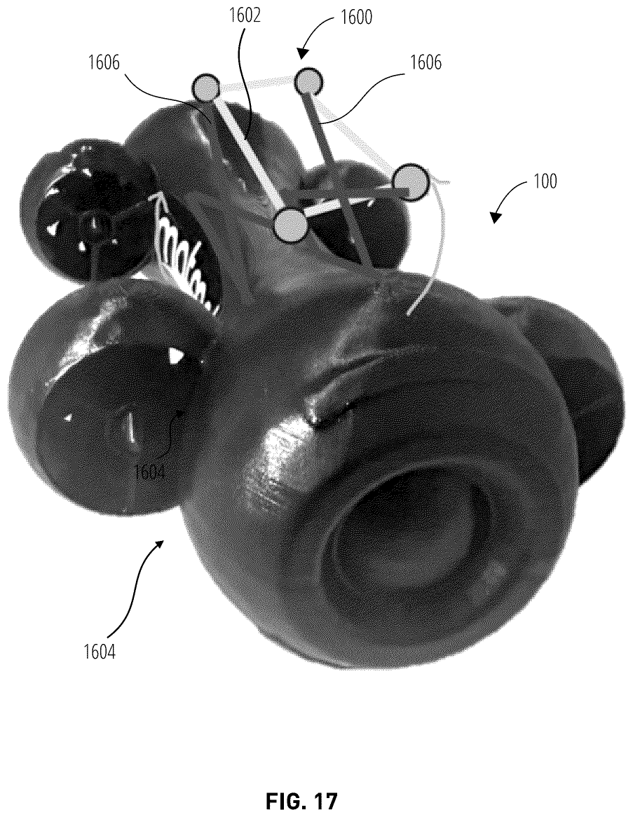

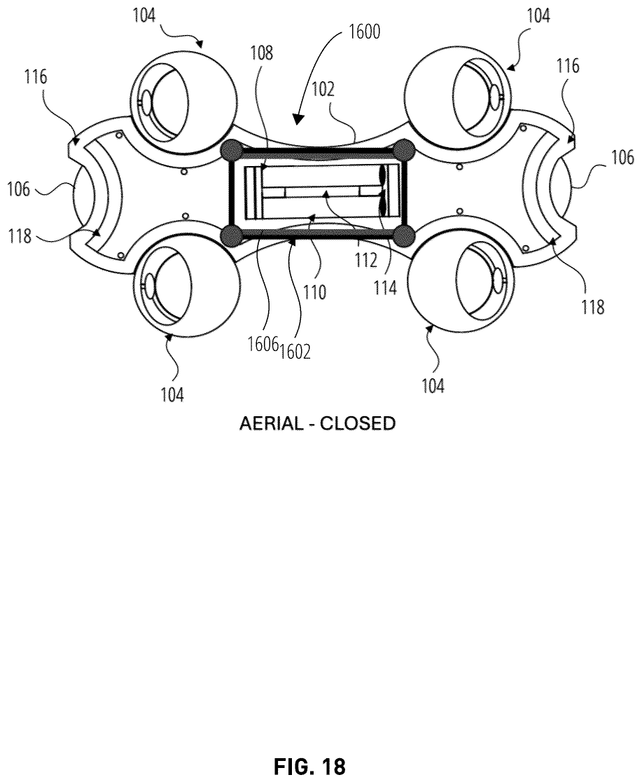

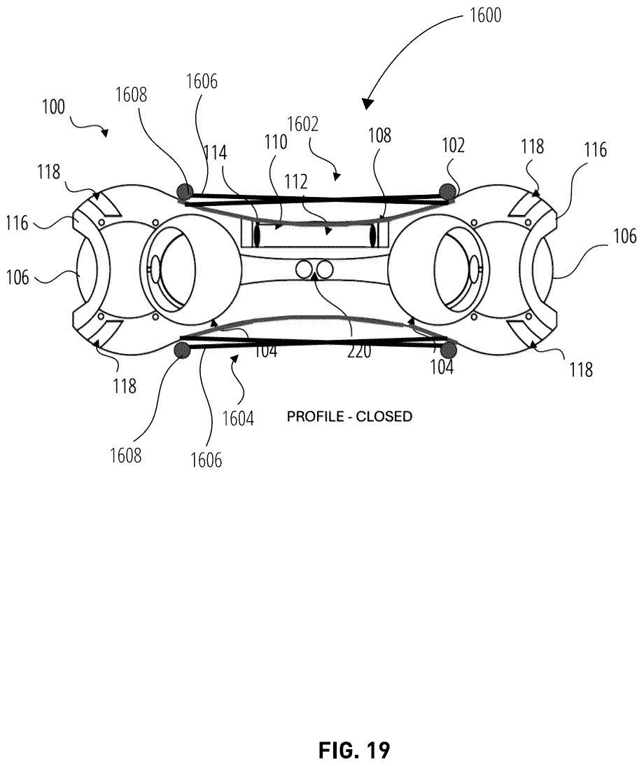

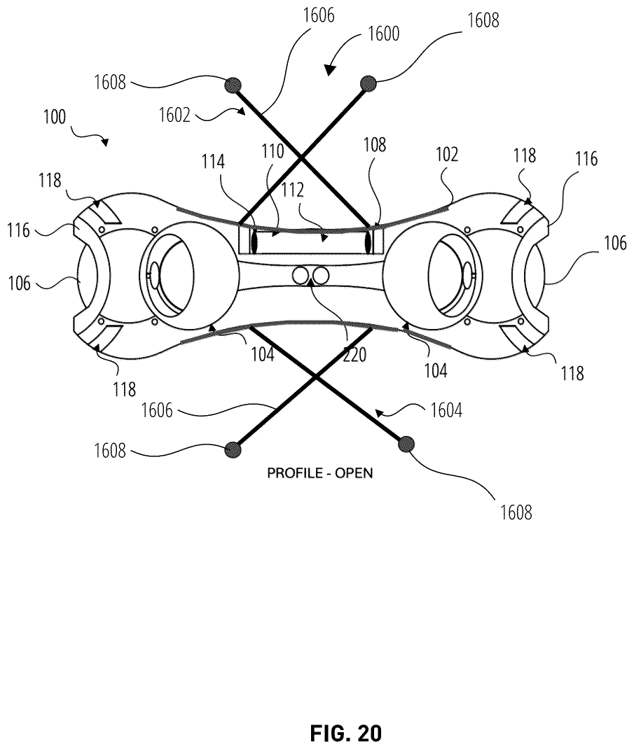

### Dual-Arm Anchoring Configuration (FIGS. 16-21)

In one embodiment, a pipe anchoring mechanism/system 1600 includes an upper anchor 1602 and a lower anchor 1604 positioned on opposing sides of the AUR body. Each anchor includes one or more extending arms 1606 that move outwardly from the AUR body 1612 to engage the pipe wall. When deployed, the arms apply a balanced compressive force to center the AUR along the pipe's longitudinal axis. The extending arms may include end caps or pads 1608 formed of non-abrasive materials to prevent pipe surface damage. A frame structure 1610 supports the arms and includes a sliding or telescoping extension mechanism. A motorized actuator controls extension and retraction, and a compression control circuit ensures equalized force distribution across the upper and lower anchors.

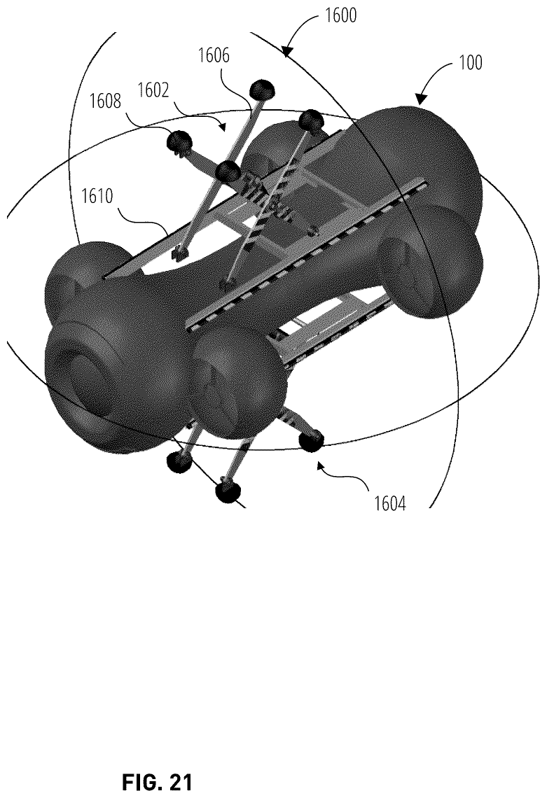

### Frame-Sliding Anchoring Configuration (FIG. 21)

In another embodiment, each upper and lower anchor includes a pair of sliding arms 1606 mounted on the frame structure 1610. These arms travel linearly along the frame to expand or contract relative to the pipe wall, providing reliable stability even in moderate fluid flow. This configuration allows the AUR to maintain position for long-duration data collection or recharging events.

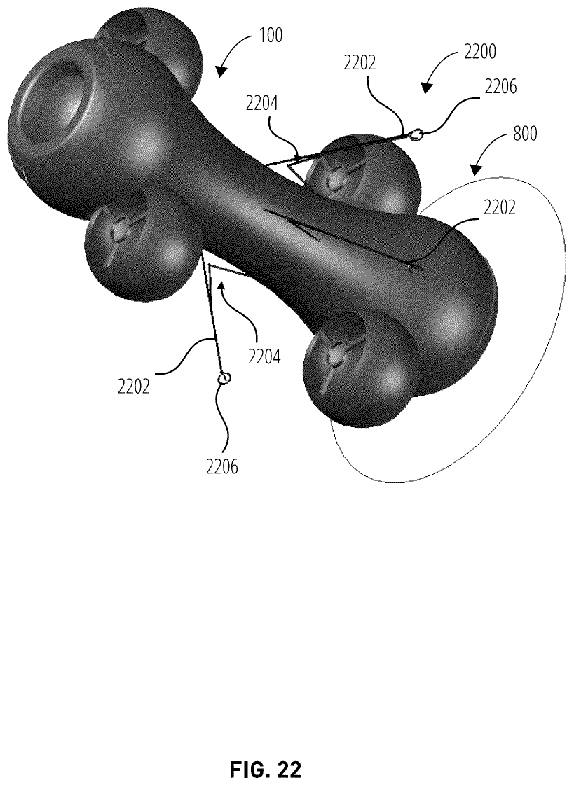

### Single-Arm Anchoring Configuration (FIG. 22)

A single-arm anchoring system 2200 includes a plurality of single extending arms 2202 positioned circumferentially around the AUR body. Each arm 2202 is extendable via an extension mechanism 2204 and terminates in a compliant end pad 2206. This design minimizes mechanical complexity while maintaining adequate stabilizing force, making it suitable for smaller-diameter or lower-pressure pipe systems.

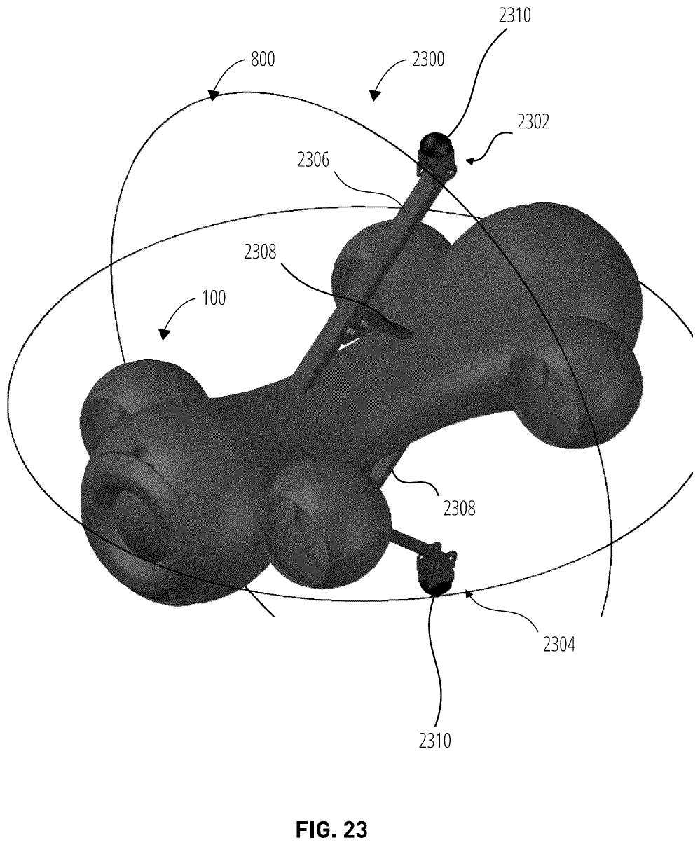

### Telescoping Anchoring Configuration (FIG. 23)

A telescoping anchoring system 2300 includes upper and lower anchors 2302 and 2304, each having telescoping arms 2306 supported by a telescoping frame 2308. The telescoping design allows for variable extension lengths, enabling adaptation to pipes of differing diameters. Each arm includes an end cap 2310 for non-destructive engagement with the pipe wall. This configuration may be suitable in applications requiring compact storage or extended reach.

The foregoing examples illustrate several anchoring system variants suitable for stabilizing autonomous underwater robotic vehicles within fluid pipelines. Each configuration can be tailored to the operational environment, pipe diameter, or inspection objective while maintaining the same functional principle-controlled, non-invasive engagement with the pipe wall. Additional modifications, materials, or actuator types may be substituted without departing from the spirit and scope of the present disclosure. The following sections describe representative figures and method-of-use examples demonstrating these and related systems in operation.

Referring to FIGS. 16-20, the present disclosure provides for a pipe anchoring system 1600 configured to integrate with an AUR 100 of the present disclosure. In this example, pipe anchoring system 1600 includes an upper anchor 1602 and a lower anchor 1604. The upper anchor 1602 and lower anchor 1604 are configured to extend from the top and bottom of the AUR body. In an example, the upper anchor 1602 and lower anchor 1604 are configured to extend simultaneously. Each of the upper anchor 1602 and lower anchor 1604 include at least one extending arm 1606 configured to extend outwardly from the AUR 1612 body. The mechanism deploys compressive force by extending arms 1606 away (i.e., upwards and downwards, anchoring the AUR 1612 to the pipe walls of pipe system 800. Upon activation, the system centers the AUR 100 within the pipe system 800's interior, ensuring stable alignment along a central axis.

The extending arms 1606 (i.e., anchoring arms) are configured to maintain a non-invasive contact profile for fluid flow. The extending arms 1606 apply sufficient force to the surrounding walls to secure the AUR 1612 in place without damaging the pipe surface. The simultaneous deployment may ensure sufficient distribution of force and consistent compression against the top and bottom sections of the pipe interior. This mechanism ensures that the AUR 100 remains stable for various tasks, including static inspections and battery recharging through in-flow energy harvesting.

Pipe anchoring system 1600 may include a frame structure 1610. Frame structure 1610 can be mounted on an underside and top side of the AUR 100's main body. In an example, frame structure 1610 can provide a base for the extending arms 1606 to extend, with a sliding mechanism for extension.

In another example, the extending arms 1606 can be telescopic anchor arms where each of the upper anchor 1602 and lower anchor 1604 includes upper and lower extending arms 1606 extending in opposite directions. The extending arms 1606 can be internally spring-loaded and deploy via a compact motorized actuator (not shown). The actuator may include an internal encoder or position sensor for precise arm extension measurement.

In a further example, pipe anchoring system 1600 includes a compression control system having a control circuit configured for regulating simultaneous extension of both the upper anchor 1602 and lower anchor 1604. This can ensure that the compression force applied to the pipe walls is evenly balanced. End cap or pads 1608 can be provided to prevent or minimize pipe damage. End caps or pads 1608 can be soft, non-abrasive material and placed on a distal end of the extending arm 1606.

In a further example, pipe anchoring system 1600 can be designed to conform slightly to different pipe diameters. It can include a central alignment mechanism by simultaneously extending both upper and lower anchors. This helps ensure that the AUR 100 is centered along a pipe's longitudinal axis. Compression can help ensure minimal or no drift or movement during stationary operations. A deployment and retraction mechanism can be motorized to extend and retract the extending arms 1606 allowing the AUR 1612 to anchor or move through the pipe system 800 as needed.

FIG. 21 illustrates a perspective view of pipe anchoring system 1600 with a frame structure 1610 and a sliding mechanism for extending the arms. This example is shown in an extended dual extending arm 1606 configuration where each of upper anchor 1602 and lower anchor 1604 include a pair of extending arms 1606. In this example, both upper anchor 1602 and lower anchor 1604 are extended. The extending arms 1606 are configured to slide back and forth within frame structure 1610.

FIG. 22 illustrates a perspective view of a single arm anchoring system 2200 configured to extend from a quad-thruster AUR 100 within a schematic pipe system 800. Single arm anchoring system 2200 includes a plurality of single extending arm 2202 positioned around quad-thruster AUR 100. Each single extending arm 2202 includes an extending mechanism 2204. In this example, the 2202 are extended. Each single extending arm 2202 can further include an end cap or pad 2206.

FIG. 23 illustrates a perspective view of a single arm telescoping anchoring system 2300 in a sliding configuration within a schematic pipe system 800. Single arm telescoping anchoring system 2300 is configured to extend from a quad-thruster AUR 100. Single arm telescoping anchoring system 2300 includes an upper anchor 2302 and a lower anchor 2304. Each of upper anchor 2302 and lower anchor 2304 includes extending arm 2306 extendable by a telescoping frame 2308. In this example, the extending arms 2306 of each of upper anchor 2302 and lower anchor 2304 are extended. Each extending arm 2306 can further include an end cap or pad 2310.

The propulsion system variants described above demonstrate the adaptability of the autonomous underwater robotic vehicles disclosed herein. Each configuration is designed to address different environmental conditions, pipe geometries, and inspection requirements while sharing the same fundamental system architecture. Whether employing quad-thruster precision control, multi-axis octo-thruster maneuverability, or simplified linear propulsion, the underlying design principles remain consistent-efficient navigation, stability, and reliability within fluid-filled pipelines. The following sections describe representative control, communication, and docking subsystems that integrate with these propulsion configurations.

There remains a potential for numerous other designs, tailored for specific operational needs or environmental conditions that are within the scope of this disclosure. It should be noted that the steps described in the method of use can be carried out in many different orders according to user preference. The use of “step of” should not be interpreted as “step for”, in the claims herein and is not intended to invoke the provisions of 35 U.S.C. § 112 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination, or addition of certain steps, including or excluding certain maintenance steps, etc., may be sufficient.

What is claimed is:

1. An anchoring system for use with an autonomous underwater robotic (AUR) vehicle for use in fluid pipe inspection, the anchoring system comprising:
(a) at least one extending/anchoring arm positioned on an upper side and a lower side of a main body of the AUR; and
(b) a motorized actuator configured for extending the extending/anchoring arm;
wherein the upper and lower extending/anchoring arms are configured to be extended simultaneously or individually as instructed by a controller and providing compressive force against an interior pipe wall of a pipe system;
wherein the extending/anchoring arms are configured to maintain a non-invasive contact profile applying just enough force to secure the robot without damaging the pipe surface.

2. The anchoring system of claim 1, wherein the at least one extending/anchoring arm further includes an end cap or pad configured to limit or prevent interior pipe surface damage.

3. The anchoring system of claim 1, further comprising a frame structure mounted on each upper and lower side of the AUR and the extending/anchoring arms extending from the frame structure.

4. The anchoring system of claim 3, wherein the frame structure includes a pair of sliding extending/anchoring arms configured to extend outwardly from the AUR.

5. The anchoring system of claim 1, wherein the extending/anchoring arms are provided in a single arm configuration.

6. The anchoring system of claim 1, wherein the extending/anchoring arms are provided in a single arm configuration having a plurality of single extending arms configured to be telescoping arms.

7. The anchoring system of claim 6, wherein the telescoping arms further include nested tubular sections configured for variable extension lengths.

8. The anchoring system of claim 1, wherein the motorized actuator comprises an electric, hydraulic, or pneumatic drive configured to generate controlled linear movement of the extending/anchoring arms.

9. The anchoring system of claim 1, further comprising a compression control circuit coupled to the controller and configured to monitor extension force to maintain balanced compression between the upper and lower extending/anchoring arms.

10. The anchoring system of claim 9, wherein the compression control circuit includes one or more pressure, torque, or displacement sensors providing feedback to the controller.

11. The anchoring system of claim 1, wherein the extending/anchoring arms are biased by an internal spring or resilient element configured to retract the arms when the actuator is de-energized.

12. The anchoring system of claim 1, wherein each extending/anchoring arm is enclosed in a watertight or pressure-resistant housing suitable for submerged operation.

13. The anchoring system of claim 1, wherein the controller is further configured to automatically retract the extending/anchoring arms upon receipt of a navigation or redeployment command.

14. The anchoring system of claim 1, wherein the controller is configured to synchronize the extension rate of the upper and lower extending/anchoring arms to center the AUR along a longitudinal axis of the pipe.

15. The anchoring system of claim 1, wherein the motorized actuator is configured to extend the arms at independent rates to compensate for irregular or asymmetric pipe geometries.

16. The anchoring system of claim 1, further comprising a sensor interface coupled to the controller for detecting pipe diameter or wall proximity prior to anchoring.

17. The anchoring system of claim 1, wherein the AUR includes a power transfer magnet or docking interface, and the anchoring system is configured to stabilize the AUR during recharging or data transfer.

18. The anchoring system of claim 1, further comprising a manual override or failsafe release mechanism to retract the arms in the event of power loss or obstruction.

19. The anchoring system of claim 1, wherein the extending/anchoring arms are articulated or jointed to conform to variations in pipe curvature or diameter.

20. An autonomous underwater robotic system, comprising:
an autonomous underwater robotic vehicle configured for movement within a fluid pipe; and
the anchoring system of claim 1 mounted to the robotic vehicle and operable to secure the vehicle in position during inspection, data transfer, or recharging operations.
